(19) United States
(12) Patent Application Publication
(10) Pub. No.: US 2017/0216948 A1
(43) Pub. Date: Aug. 3, 2017

(54) SOLDERING JIG FOR DOUBLE-FACED COOLING POWER MODULE

(71) Applicants: Hyundai Motor Company, Seoul (KR); Hyundai Autron Co., Ltd., Seongnam (KR)

(72) Inventors: Sung Won Park, Incheon (KR); Ki Young Jang, Incheon (KR); Hyun Koo Lee, Seoul (KR); Sung Min Park, Seoul (KR); Woo Yong Jeon, Seoul (KR); Jeong Min Son, Seongnam (KP); Moo Soo Jeong, Yongin (KR); Mun Ki Ko, Yongin (KR)

(21) Appl. No.: 15/213,840

(22) Filed: Jul. 19, 2016

(30) Foreign Application Priority Data
Feb. 3, 2016 (KR) 10-2016-0013605

(51) Int. Cl. B23K 3/08; B23K 1/00

(52) U.S. Cl. CPC B23K 3/085; B23K 1/0016

(57) ABSTRACT

A soldering jig for double-faced cooling power modules is provided. The soldering jig prevents thermal deformation of a substrate during a soldering process. The soldering jig is used to fix the position of an upper substrate and a lower substrate when a semiconductor chip is disposed and soldered between the upper and lower substrates. The soldering jig includes a lower jig plate that is disposed under the lower substrate and fixes the position of lower substrate, an upper jig plate that is disposed over the upper substrate and compresses the upper substrate toward the lower substrate. Additionally, a connector which couples the lower jig plate and the upper jig plate, and an insert is installed on the connector and is disposed between the upper substrate and the lower substrate to maintain a constant distance between the upper substrate and the lower substrate during a soldering process.

### CROSS REFERENCE TO RELATED APPLICATION

The present applicationclaims priority of Korean Patent Application No. 10-2016-0013605 filed on Feb. 3, 2016, the entire contents of which is incorporated herein for all purposes by this reference.

### BACKGROUND

Field of the Invention

The present invention relates to a soldering jig for double-faced cooling power modules, and more particularly, to a soldering jig for double-faced cooling power modules capable of preventing thermal deformation of a substrate during a soldering process.

Description of the Related Art

Typically, a hybrid power control unit (HPCU) (e.g., inverter), used to drive an environment-friendly vehicle (hybrid/electric vehicle) provides a critical component for development of environment-friendly vehicles. Among elements constituting the HPCU, a power module contributes to a large percentage of the production cost of the HPCU and is a key component for driving the HPCU. Accordingly, the related technical development has become appreciably more active. The development of the power module provides important technical considerations to maintain the lead in technical competition in the environment-friendly vehicle industry.

Recently, technology development for power modules has been focused on enhancing the cooling performance and reducing the production cost. The enhancement of the cooling performance makes it possible to reduce rated current of an insulated-gate bipolar transistor (IGBT) and a diode and thus reliably operate the power module. Further, the size of a chip may be reduced and a reduction in production cost occurs. To enhance the cooling performance, the structure (e.g., single-faced or double-faced structure) of the power module and the shape of a cooler is developed. In particular, a power module having a double-faced cooling structure, may provide excellent heat dissipation characteristics, is currently being researched.

To manufacture a double-faced cooling power module, a bonding process electrically or physically couples a semiconductor chip (device) on a ceramic insulating substrate provided with copper (Cu) electrodes or aluminum (Al) electrodes. A soldering process that uses the melting or solidifying of solder, which is a fusible metal alloy for bonding, is used as the bonding process that couples the chip to the substrate. Generally, soldering uses a soldering jig for fixing elements including a semiconductor chip and includes heating the elements to a high temperature (e.g., about 200° C. or greater), and cooling the elements to solidify solder.

During the soldering process, a rapid temperature change may cause deformation of some elements due to a difference in thermal expansion coefficient between the elements. For example, when the ceramic insulating substrate in which the copper (Cu) electrodes or the aluminum (Al) electrodes having a high thermal expansion coefficient are attached on a ceramic plate having a low thermal expansion coefficient, stress is applied to the element by a substantial difference in thermal expansion coefficient between ceramic and copper (Cu) or ceramic and aluminum (Al). Accordingly, the insulating substrate may be bent due to the stress. The bending phenomenon of the insulating substrate may reduce the cooling performance of the power module or increase in the production cost due to an additional process for securing the surface flatness of the insulating substrate being required.

In particular, when a soldering process is performed using a conventional typical jig, the perimeters of an upper substrate 10 and a lower substrate 10 are bent toward each other. Consequently, a surface area in contact with a cooler 20 is reduced, and an application amount of thermal grease (e.g., thermal interface material TIM) that enhances heat transfer efficiency between the upper and lower substrates is increased. To overcome these problems, when polishing or removing an increased-thickness portion of the upper substrate 10 and the lower substrate 10 is performed, an additional operation is requited, thus increasing processing time and cost

The present invention uses a soldering jig for power modules with an improved structure and simplifies the process and reduces the production cost, and mitigates the bending phenomenon of the insulating substrate that occurs when the conventional power module is manufactured, and thereby enhances the cooling performance.

The above information disclosed in this section is merely for enhancement of understanding of the background of the invention and therefore it may contain information that does not form the prior art that is already known in this country to a person of ordinary skill in the art.

### SUMMARY

The present invention provides a soldering jig for double-faced cooling power modules for manufacturing a power module having improved heat dissipation performance.

According to one aspect, a soldering jig may include a lower jig plate disposed beneath the lower substrate and configured to the lower substrate in place, an upper jig plate disposed over the upper substrate and configured to compress the upper substrate toward the lower substrate and a connector may couple the lower jig plate and the upper jig plate to each other. An insert may be installed on the connector and disposed between the upper substrate and the lower substrate, the insert may be configured to maintain a substantially constant distance between the upper substrate and the lower substrate during a soldering process. For example, the double-faced cooling power modules may be used to fix an upper substrate and a lower substrate in place when a semiconductor chip is disposed and soldered between the upper substrate and the lower substrate.

The upper jig plate may be brought into contact with an upper surface of the upper substrate and formed in a shape in which the upper jig plate contacts a central portion of the upper substrate and may be separated from a perimeter of the upper substrate. The lower jig plate may be formed to be greater than the lower substrate and the upper jig plate may be formed to be greater than the upper substrate. The connector may couple the upper jig plate and the lower jig plate to each other and may include a plurality of coupling pins separated from the upper substrate and the lower substrate.

The insert may be fixed to the connector may be formed in a block shape and may be brought into close contact with each of the upper substrate and the lower substrate. The insert may be configured to compress the lower substrate toward the lower jig plate and fix the lower substrate to the lower jig plate.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary view showing a conventional double-faced cooling power module according to the related art;

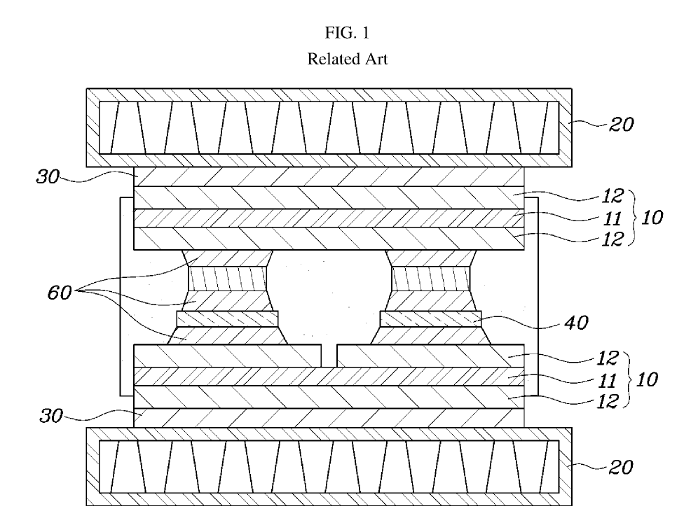

FIG. 2 is an exemplary view showing the installation of a jig in an operation of soldering the conventional double-faced cooling power module according to the related art;

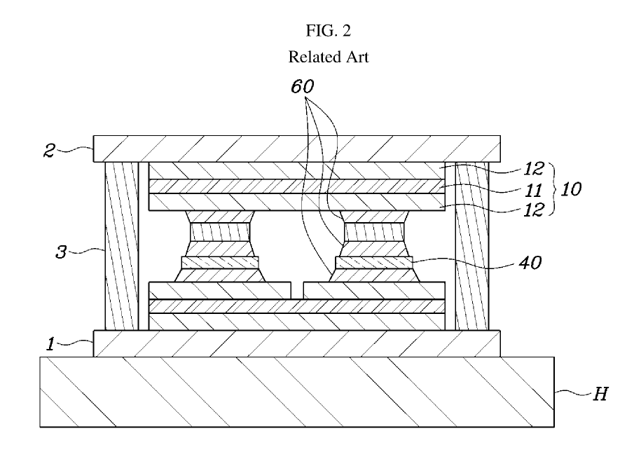

FIG. 3 is an exemplary view showing a bending phenomenon caused on a substrate during the operation of soldering the conventional double-faced cooling power module according to the related art;

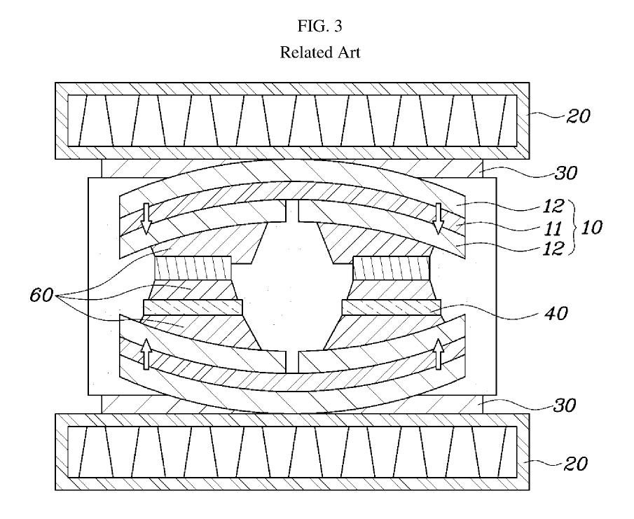

FIG. 4 is an exemplary view showing an operation of cutting off portions of the substrate bent during the operation of soldering the conventional double-faced cooling power module according to the related art;

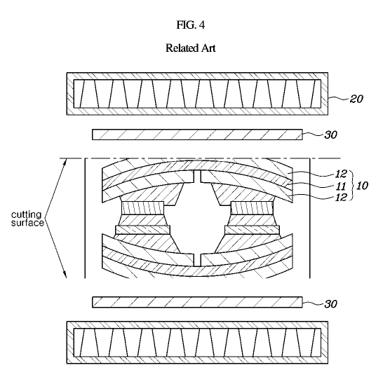

FIG. 5 is an exemplary view illustrating the installation of a soldering jig for a power module according to an exemplary embodiment of the present invention;

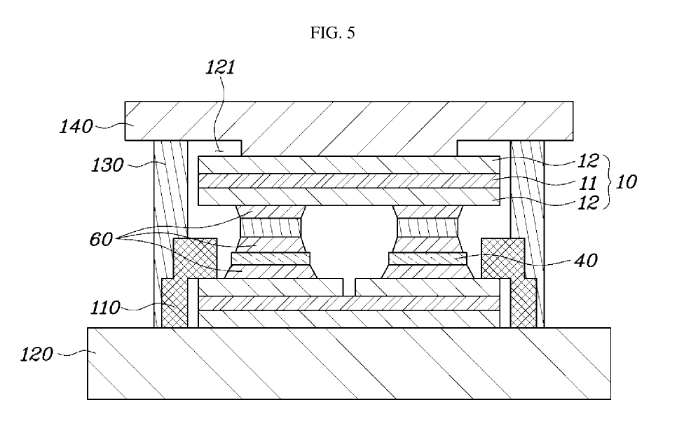

FIG. 6 is an exemplary perspective view illustrating a lower substrate, a connector, and an insert that are installed on a lower jig plate according to an exemplary embodiment of the present invention; and

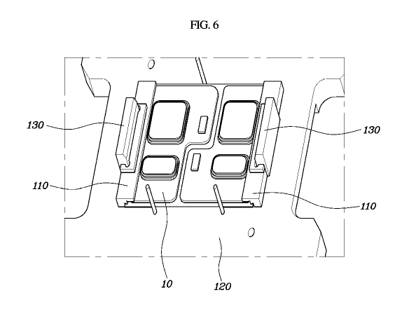

FIG. 7 is an exemplary graph showing thickness deviations of power modules that are manufactured using the conventional jig and the jig according to an exemplary embodiment of the present invention.

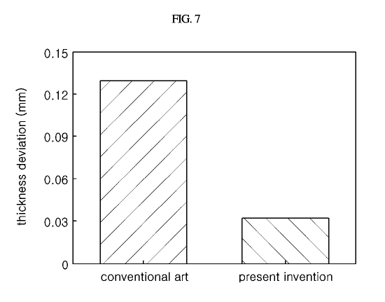

### DETAILED DESCRIPTION

Herein below, an exemplary embodiment of the present invention will be described in detail with reference to the accompanying drawings. Throughout the drawings, the same reference numerals will refer to the same or like parts.

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the tem) “about.”

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

Hereinafter, a soldering jig for a double-faced cooling power module according an exemplary embodiment of the present invention will be described in detail with reference to the attached drawings.

The present invention relates to a soldering jig for a double-faced cooling power module that may be used to fix an upper substrate 10 and a lower substrate 10 in place when a semiconductor chip 40 is disposed and soldered between the upper substrate 10 and the lower substrate 10. The soldering jig may include a lower jig plate 120 disposed under the lower substrate 10 and configured to fix the lower substrate 10 in place, an upper jig plate 140 may be disposed over the upper substrate 10 and configured to compress the upper substrate 10 toward the lower substrate, a connector 130 that couples the lower jig plate 120 and the upper jig plate 140 to each other and an insert 110 installed on the connector 130 and disposed between the upper substrate 10 and the lower substrate 10 to maintain a substantially constant a distance between the upper substrate 10 and the lower substrate 10 during a soldering process. The upper substrate 10, the lower substrate 10, and a semiconductor chip 40 may be provided with a solder 60 interposed therebetween and may be bonded to each other by melting the solder 60 and solidifying the melted solder 60. This is well known in the alt; therefore, further detailed explanation thereof will be omitted in the present invention.

The upper jig plate 140 and the lower jig plate 120 of the conventional art are coupled to each other merely by the connector 130 and the deformation of the upper substrate 10 and the lower plate 10 by heat. Further, the upper substrate 10 and the lower plate 10 are bent toward each other. However, in the present invention, the insert 110 may be disposed between the upper substrate 10 and the lower substrate 10 and thus may prevent the upper substrate 10 and the lower substrate 10 from thermal deformation and subsequent bending. In other words, when the upper substrate 10 and the lower substrate 10 are intended to be bent by heat, the insert 110 disposed at a position that corresponds to the direction in which the upper and lower substrates 10 are bent, may be configured to compress the upper substrate 10 and the lower substrate 10 toward the upper jig plate 140 and the lower jig plate 120. The upper jig plate 140 may have a shape that contacts an upper surface of the upper substrate 10, and more particularly, contacts a central portion of the upper surface of the upper substrate 10 and may be separated from the perimeter of the upper substrate 10.

In particular, he upper jig plate 140 may be in close contact (e.g., abutting, contact) with the upper surface of the upper substrate 10. Accordingly, the thermal stress of the upper substrate 10 may be excessively increased during a cooling process after the soldering process and the upper substrate 10 may be damaged. Therefore, a lower surface of the upper jig plate 140 may be micro-machined to contact the central portion of the upper substrate 10 and separated from (e.g., spaced apart from) the perimeter of the upper substrate 10. In other words, when the contact area between the upper substrate 10 and the upper jig plate 140 is adjusted, a cooling rate may vary based on regions of the upper substrate 10. Thereby, the thermal stress of the upper substrate 10 may be mitigated.

The lower jig plate 120 may be formed to be greater than the lower substrate 10 and the upper jig plate 140 may be formed to be greater than the upper substrate 10. The connector 130 may couple the lower jig plate 120 and the upper jig plate 140 and may include a plurality of coupling pins that may be separated from the upper substrate and the lower substrate (e.g., makes contact with neither the upper substrate nor the lower substrate). Accordingly, when the connector 130 contacts the upper or lower substrate 10, lateral thermal deformation of the upper or lower substrate 10 when heated may be impeded by the connector 130, whereby excessive thermal stress may be applied to the upper or lower substrate 10.

The insert 110 may be fixed to the connector 130, may be formed in a block shape, and may be brought into close contact with each of the upper substrate 10 and the lower substrate 10. In other words, since the insert 110 may be in close contact with each of the upper surface of the lower substrate 10 and with the lower surface of the upper substrate 10, the insert 110 may prevent the upper substrate 10 from being bent downward or the lower substrate 10 from being bent upward. The insert 110 may compress the lower substrate 10 toward the lower jig plate 120 and may fix the lower substrate 10 to the lower jig plate 120.

For example, the lower substrate 10 may be disposed on the lower jig plate 120 and the connector 130 may be fixed on the lower jig plate. Thereafter, the insert 110 may be installed on the connector 130, with the upper surface of the lower substrate 10 in contact with the insert 110. The insert 110 may be fixed to the connector 130 or the lower jig plate 120 by a screw or other fastening mechanism. In other words, the upper surface of the lower substrate 10 may be compressed downward. Thus, the lower substrate 10 may be prevented from being bent. Thereafter, the solder 60, the semiconductor chip 40, and the upper substrate 10 may be stacked on the lower substrate 10. The upper jig plate 140 may be disposed on the upper substrate 10 and coupled to the connector 130. In other words, the upper jig plate 140 may be coupled to the connector 130 and the upper jig plate 140 may be configured to compress the upper surface of the upper substrate 10.

Compared to the conventional art in which a maximum thickness, a minimum thickness, an average thickness, and a thickness standard deviation of the power module are respectively about 4.78 mm, 4.34 mm, 4.50 mm, and 0.13 mm and thus a thickness deviation is comparatively substantial. Conversely, when the jig according to the present invention having the above-mentioned configuration is used, to maximum thickness, a minimum thickness, an average thickness, and a thickness standard deviation of the power module may be respectively 4.82 mm, 4.65 mm, 4.70 mm and 0.032 mm. Namely, the present invention provides a power module with a minimal thickness deviation.

Therefore, it should be understood that the exemplary embodiment is only for illustrative purpose and do not limit the bounds of the present invention. It is intended that the bounds of the present invention are defined by the accompanying claims, and various modifications, additions and substitutions, which can be derived from the meaning, scope and equivalent concepts of the accompanying claims, fall within the bounds of the present invention.

As described above, a soldering jig for a double-faced cooling power module according to the present invention has the following effects.

First, cutting, polishing, and grinding processes for flattening a power module may be omitted, to simplify the overall process.

Second, the contact force between a cooler and the power module may be enhanced, and thus the cooling performance may be improved.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A soldering jig for double-faced cooling power modules to fix a position of an upper substate and a lower substrate when a semiconductor ship is disposed and soldered between the upper substrate and the lower substrate, the soldering jig comprising:
a lower jig plate disposed under the lower substrate and configured to fix the position of the lower substrate;
an upper jig plate disposed over the upper substrate and configured to compress the upper substrate toward the lower substrate;
a connector configured to couple the lower jig plate and the upper jig plate; and
an insert disposed on the connector and positioned between the upper substrate and the lower substrate, wherein the insert is configured to maintain a substantially constant distance between the upper substrate and the lower substrate during a soldering process,
where the upper jig plate contacts an upper surface of the upper substrate and is formed in a shape in which the upper jig plate contacts a central portion of the upper substrate and is separated from a perimeter of the upper substrate.

2. (canceled)

3. The soldering jig according to claim 1,
wherein the lower jig plate is formed to have a size greater than the lower substrate, and the upper jig plate is formed to have a size greater than the upper substrate, and
wherein the connector couples the upper jig plate and the lower jig plate to each other

4. The soldering jig according to claim 3, wherein the insert is fixed to the connector, is formed in a block shape, and is brought into contact with the lower substrate.

5. The soldering jig according to claim 4, wherein the insert is configured to compress the lower substrate toward the lower jig plate and fixes the lower substrate to the lower jig plate.

6. The soldering jig according to claim 3, wherein the insert is fixed the lower jig plate.
